(19) United States
(12) Patent Application Publication
(10) Pub. No.: US 2006/0232413 A1
(43) Pub. Date: Oct. 19, 2006

(54) RFID tag with antenna comprising optical code or symbol

(75) Inventors: For Sander Lam, Bothell, WA (US); Venkata S. Kodukula, Bothell, WA (US); Pavel V. Nikitin, Seattle, WA (US); Vijay Pillai, Mukilteo, WA (US)

Correspondence Address: BRIAN M BERLINER, ESQ;O'MELVENY & MYERS, LLP, 400 SOUTH HOPE STREET, LOS ANGELES, CA, 90071-2899, US

(73) Assignee: INTERMEC IP CORP.

(21) Appl. No.: 11/403,746

(22) Filed: Apr. 12, 2006

Related U.S. Application Data
(60) Provisional application No. 60/671,211, filed on Apr. 13, 2005.

(51) Int. Cl. G08B 13/14

(52) U.S. Cl. 340/572.1

(57) ABSTRACT

A radio frequency identification (RFID) tag includes an antenna having a shape providing a machine-readable or human-readable code or symbol. For example, a machine-readable code may comprise a bar code, or other suitable optical code. Human-readable symbols may include, for example, text, alpha-numeric symbols, icons, or pictographs. Using human-readable antenna forms, an RFID tag may be used as a label, for example, to add a distinctive look to the tagged product, to further identify the tag or product it is attached to, or for branding the tag or attached product.

### RELATED APPLICATION DATA

This patent application claims priority pursuant to 35 U.S.C. § 119(e) to provisional patent application Ser. No. 60/671,211, filed Apr. 13, 2005, the subject matter of which is incorporated herein in its entirety.

### BACKGROUND OF THE INVENTION

1. Field of the Invention

The present invention relates to radio frequency identification (RFID) systems and more particularly, to an antenna for an RFID transponder or tag.

2. Description of Related Art

Radio frequency identification technology is a wireless technology for data transfer used in many different applications, such as electronic toll collection, railway car identification and tracking, intermodal container identification, asset identification, tracking and item management for retail, health care and logistics applications. An RFID system includes one or more transponders, i.e., tags, comprised of a semiconductor chip and an antenna, and one or more read/write devices, also called readers or interrogators, each connected to its own antenna.

RFID provides certain advantages over conventional optical encoding systems such as bar coding. Bar code systems use a reader to optically transfer information from coded labels that are attached to an item, whereas RFID systems use radio waves to transfer data between a reader and RFID tags that are attached to an item. The reader sends out a radio frequency signal to query an RFID tag which may be at some distance from the reader, or even moving in relation to the reader. Any RFID tags tuned to that frequency will detect the query signal and respond by transmitting a signal with their stored data to the reader. Unlike bar code systems that depend on optical transfer of information, RFID tags may be readable at a distance and without requiring direct line of sight view by the reader. The RFID tags may also. have a memory capacity of several kilobytes or more, which is substantially greater than the maximum amount of data that may be contained in a bar code symbol or other optical code in a small space. The information transferred from an RFID tag may include data about the item, for example, what the item is, the item serial number, what time the item traveled through a certain zone, even the temperature at which the item has been stored or other data provided by sensors.

Typically, an RFID tag consists of an RFID chip, including RF circuitry, control logic and memory, attached to a radiation antenna that is formed on a low cost dielectric substrate such as polyester, FR4, or other suitable material. Typical RFID tag antenna designs may include, for example, conventional dipole, loop, spiral, patch, slot, or meander designs. All these antennae are well known and described in the prior art. Any particular selected antenna design is based on desired form, fit, and functional performance. Generally, omnidirectionality for the transponder antenna is preferred to ensure identification from all directions. Additionally, the antenna should be small in size and have a low profile. Meander line antennas have typically been used to reduce the size of radiating elements in wire antennas. The antenna is formed of conductors printed, plated, deposited or etched on a non-conductive substrate, which may be flexible or rigid. The antenna may be attached by a solder or adhesive to an electronic integrated circuit to form an RFID tag.

RFID tags are often placed in or under a label that is printed with a machine-readable bar code and/or some human-readable information. While the RFID tag may be used to hold and communicate a relatively large amount of digital information, often additional optical codes or symbols such as bar codes, text, literal strings or other machine-readable optical codes or symbols are also desired to identify the label itself, to provide redundancy or alternative methods for reading label information, or for branding. Notwithstanding the advantages of such optical labels, they are subject to certain limitations. For example, it may be desirable to more securely associate the optical code or label with the RFID tag, since separate optical codes or labels may be separated from the RFID tag and lost, or replaced with an incorrect code or label. Prior art RFID devices may also lack a distinctive and attractive look, which would be beneficial for applications such as consumer packaging or for brand promotion. It is desirable, therefore, to provide an RFID device for overcoming these and other limitations of the prior art.

### SUMMARY OF THE INVENTION

The present invention provides an RFID antenna that overcomes the limitations of the prior art. Specifically, an RFID tag antenna according to the invention comprises a machine-readable or human-readable code or symbol. For example, a machine-readable code may comprise a bar code, or other suitable optical code. Human-readable symbols may include, for example, text, alpha-numeric symbols, icons, or pictographs. Using human-readable antenna forms, an RFID tag may be used as a label, for example, to add a distinctive look to the tagged product, to further identify the tag or product it is attached to, or for branding the tag or attached product.

In an embodiment of the invention, an RFID tag antenna may be constructed as a bar code comprising a conducting trace transversely intersecting a set of parallel conductive traces of varying width and spacing. The transverse intersecting trace connects the antenna to an RFID chip, while the set of parallel conductive traces is configured in the form of a bar code. The bar code may be used to optically encode information independently of the RFID memory, while maintaining a strict correspondence between a particular optical code value and a particular RFID device. For example, an antenna configured as a bar code may be optically scanned and provided to an RFID reader. An RFID reader may activate for reading more detailed or confirming information stored in the RFID chip. The information contained in the RFID chip connected to the bar code antenna may be more detailed than the information encoded in the bar code, because the RFID chip usually has more data capacity than a bar code.

For many applications, it may be desirable to optically encode various different data using an optical code, without substantially altering the RF characteristics of the antenna when different data is encoded. If so, different RFID tags can be provided that may all be used in the same way as an RFID device, while encoding different data in the shape of the antenna. Thus, RFID tags may be securely identified using the antenna configuration, for any desired application. Because the form of many optical codes generally changes depending on the encoded data, maintaining substantially the same RF characteristics while optically encoding different data may require special attention to the way in which the antenna is configured. The present disclosure describes a suitable method for configuring an antenna as an optical bar code that may encode different data while preserving substantially similar RF characteristics for different data. Because the optical code cannot be altered without destroying the antenna, users may obtain a greater assurance that an RFID tag is valid, or comes from a trusted source.

Generally, the length of a longest conductive line in an RFID tag antenna determines the tag resonant frequency. In an embodiment of the invention, an RFID antenna also functioning as a bar code comprises a series of parallel traces of varying width and spacing. These parallel traces may be connected by a transverse trace intersecting each of the parallel traces. In a suitable bar code, the relative spacing of the parallel antenna traces should not significantly affect the antenna gain or its resonant frequency as long as the area occupied by the series of lines, i.e., the bar code size, remains the same. Thus, the frequency of the tag antenna may be independent of the bar code pattern as long as the various patterns occupy the same area. Meanwhile, the transverse antenna trace may also comprise the longest continuous conductive line, thereby determining by its length the antenna resonant frequency.

In an alternative embodiment, the RFID tag antenna may be constructed in the form of electrically inter-connected, human-readable symbols or characters, such as text. For example, the RFID tag antenna may be constructed as an interconnected metal or conductive trace resembling group of symbols or letters displaying a given trademark or company logo, such as INTERMEC™. Such antennas may be designed to have RF characteristics within a useful range, as disclosed herein.

In general, conductive antenna traces in the form of characters, optical codes or symbols may be formed on top of a dielectric layer, such as by printing or etching, using a suitable conductive material such as copper, or a conductive ink. The conductive characters may then be chained or linked together with short conductive traces. An RFID chip may be connected to the antenna trace at any desired point. In an embodiment of the invention, the RFID chip is inserted approximately midway between traces of the same or similar length. The height and width of the characters, codes or symbols may be varied to fit the tag size requirement. To tune the antenna frequency and optimize the RFID tag performance, antenna RF matching components, such as inductors, may be printed or inserted between the RFID chip and a connected tag antenna.

In the foregoing embodiment, folds in the interconnected letters of text may comprise either a uniform or non-uniform meander line antenna element, depending on a selected text font and placement of the conductive traces connecting the letters of text. Folds along the length of the antenna trace may reduce the resonant frequency of the antenna, compared with a straight dipole antenna of the same axial length. This reduction in resonant frequency may be proportional to the total wire length. Thus, using interconnected text as the antenna element may reduce the effective axial length of the antenna by a predictable degree, which may be readily corrected for when configuring an antenna to convey different alpha-numeric or other human-readable information.

A more complete understanding of the RFID tag having an antenna formed in the shape of a machine-readable or human-readable code or symbol will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a diagram showing an RFID tag antenna comprising an optical code or symbol in accordance with an embodiment of the present invention.

FIGS. 2A and 2B are plan and side views, respectively, of a prototype of an RFID tag antenna in accordance with an embodiment of the present invention.

FIGS. 3A and 3B are plan and side views, respectively, of a second prototype of an RFID tag antenna comprising an optical code, encoding different data than the prototype shown in FIGS. 2A-B.

FIG. 4 is a graph showing a frequency response curve for the prototypes depicted in FIGS. 2A-3B.

FIGS. 5A-B are enlarged plan and side views, respectively, showing a prototype of a human-readable RFID tag antenna, comprising an “Intermec” symbol in accordance with an embodiment of the invention.

FIG. 6 is a graph showing a frequency response curve for the prototype depicted in FIG. 5.

### DETAILED DESCRIPTION OF THE PREFERRED EMBODIMENT

The present invention provides an RFID tag with an antenna comprising an optical code or symbol, for example, a machine-readable bar code or human-readable text. In the detailed description that follows, like element numerals will be used to indicate like elements appearing in one or more of the figures.

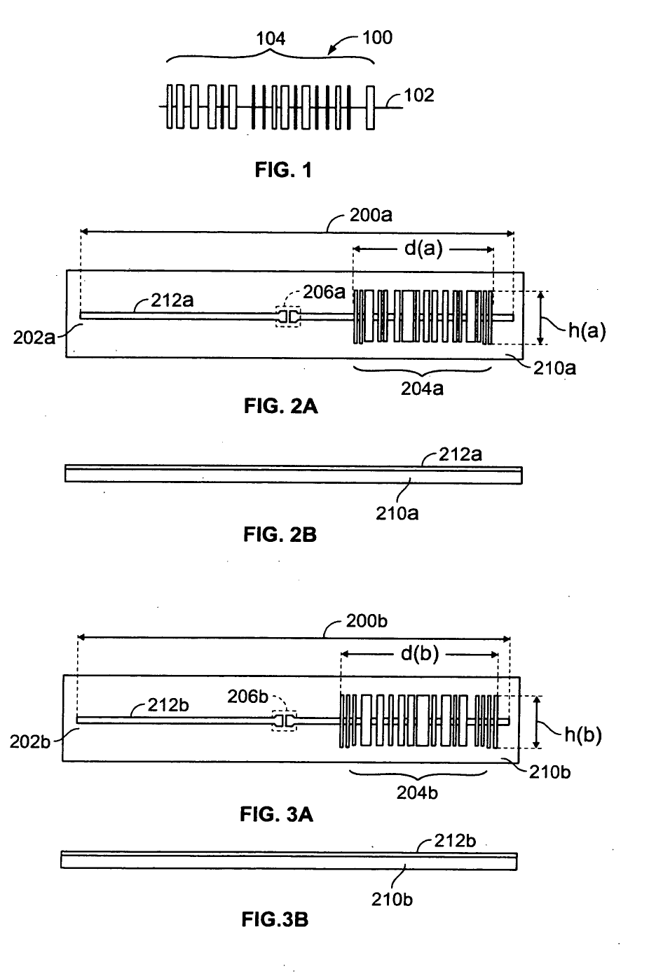

FIG. 1 is a diagram showing an RFID tag antenna 100 configured as a machine-readable code in accordance with an embodiment of the present invention. In RFID antenna 100, horizontal line 102 denotes a transverse conductive trace and a series of vertical lines 104 connected by trace 102 are configured as an optical bar code. The length of the horizontal trace 102 determines the tag resonant frequency and the antenna gain. The series of vertical traces 104 may improve antenna bandwidth, but different vertical arrangements, so long as occupying the same area, should not appreciably change the antenna resonant frequency or gain of the illustrated design. For example, the spacing of the vertical traces should have relatively little effect on the tag range. The antenna may accommodate any configuration of bar code data without affecting the its range, as long as the area occupied by the vertical traces remains the same.

FIGS. 2A-B and 3A-B are diagrams showing plan and side views of two machine-readable tag embodiments 200a and 200b optically encoding different data. RFID tags 200a, 200b may be constructed using a dielectric substrate and metallic trace as known in the art, for example, 30 mil Rogers 4003 dielectric substrate material 210a, 210b with 1.4 mil copper layer conductive material 212a, 212b as conductive traces. Both machine-readable tags 200a and 200b comprise bar codes in UPC-E standard; that is, vertical traces 204a and 204b are configured to comprise an optical bar code. Any other suitable coding system may be used. Tag 200a comprises a bar code antenna encoding data 05432109. Tag 200b comprises a bar code antenna encoding data 00123457. Both tags 200a and 200b may comprise horizontal traces 202a and 202bbisecting a series of vertical traces 204a and 204b. RFID chips 206a and 206b may be interposed between the horizontal traces 202a and 202b. The horizontal traces 202aand 202b comprise transverse traces of the tag antennas determining their respective resonant frequencies. All horizontal traces 202a and 202b and vertical traces 204a and 204b may be constructed of the same conductive material. In the alternative, different compatible materials may be used. The background substrate and the trace material should be selected to provide adequate contrast in optical characteristics, so as to enable readability of the code. For a particular antenna design, horizontal lines 202aand 202b may be substantially the same length and both bar code areas, defined by h(a)×d(a) and h(b)×d(b), should be substantially equal. Within these constraints, the pattern of vertical lines 204a and 204b may differ so as to encode different data, without substantially affecting the antennae's electrical characteristics.

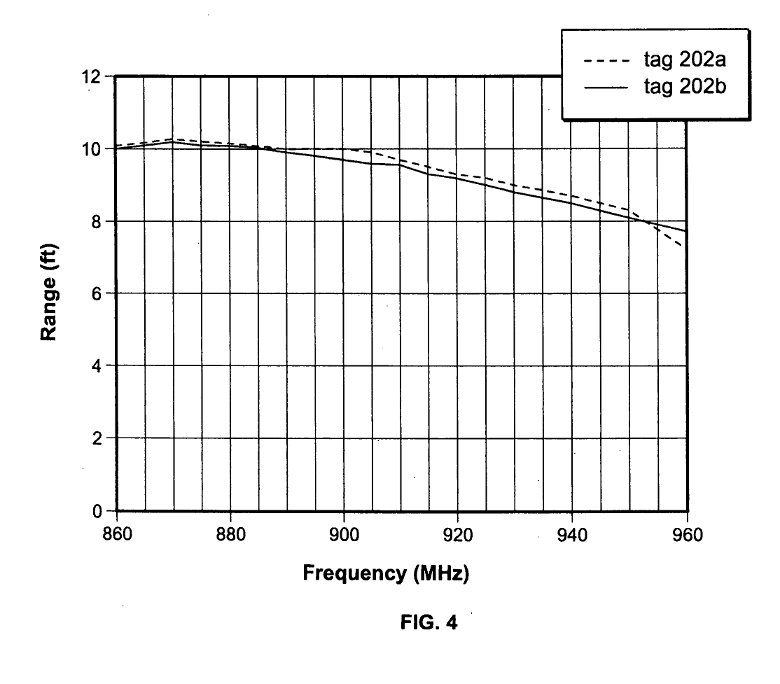

FIG. 4 shows exemplary tag performance results for RFID tags 202a and 202b. Results are shown such as may be achieved from tests in an anechoic chamber at a fixed distance from the RFID scanner, with the RFID tag oriented in the direction of maximum tag gain with respect to an RFID reader. At each selected frequency, the results show an exemplary minimum power required to communicate with the tag, such as may be recorded using an RFID reader. FIG. 4 shows very similar performance over a range of frequencies for both tags, despite their different antenna configurations for encoding different data. For example, the resonant frequency for both tags 202a and 202b is 869 MHz, where the range reaches a maximum (10 feet in this example) and the performance is best. Different information may therefore be encoded in different RFID antennas, without substantially altering the RF response characteristics of the RFID device. Thus, RFID devices with antennae optically encoding different data may be used together in the same system of RFID readers.

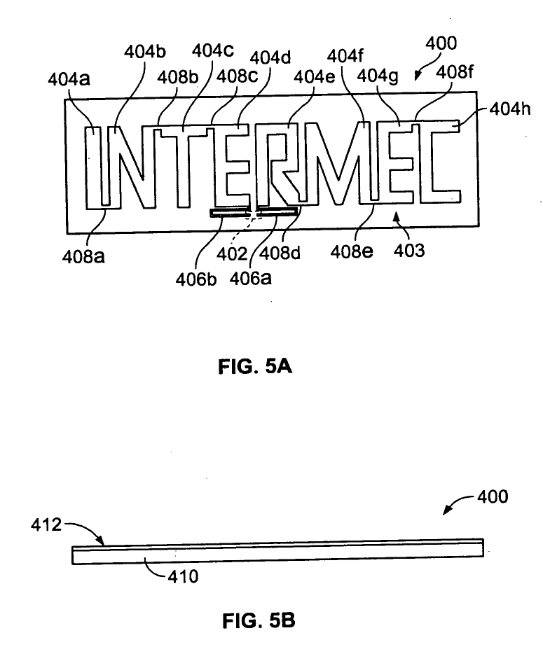

FIGS. 5A-B are plan and side views, respectively, showing a human-readable RFID tag 400 in accordance with another embodiment of the present invention. RFID tag 400 includes an RFID chip 402, an RFID tag antenna 403 and matching components 406a-b. RFID tag antenna 403 is constructed as electrically interconnected human-readable characters, here displaying the word “INTERMEC.” The copper (or other metallic) characters 404a-h may be formed, such as by printing or photo-etching, on top of a dielectric layer and chained together with short conductive traces 408a-f. A small gap may be provided at an intermediate position in the chain for the RFID chip 402. Matching components 406a-b, such as inductors or capacitors, may be printed or inserted between the RFID chip 402 and the tag antenna chain 403 to improve the matching between the RFID chip and tag antenna, to tune the antenna or otherwise optimize the antenna performance.

A series of human-readable characters (e.g., “I, N, T, E, R, M, E, C”) may be formed using a thin copper or other conductive layer 412 on a suitable dielectric substrate 410, such as on a 1 oz polyester substrate. The characters may be interconnected with short metal traces 408a-f to form tag antenna 403. This configuration should provide sufficient visible contrast between the traces and the substrate, such that the formed characters are readily perceived. Other combinations of materials may also provide suitably perceptible contrast. Suitable methods for forming conductive antenna traces on flexible or rigid dielectric substrates are known in the art, and any suitable method may be used.

The height and width of the characters may be varied to accommodate the tag size requirement. The characters may be chained to create an electrical length close to the desired frequency. Various different characters may be chained to spell out any desired word or phrase. In this embodiment, the meander length of the connected letters or symbols may comprise a key characteristic influencing antenna resonant frequency.

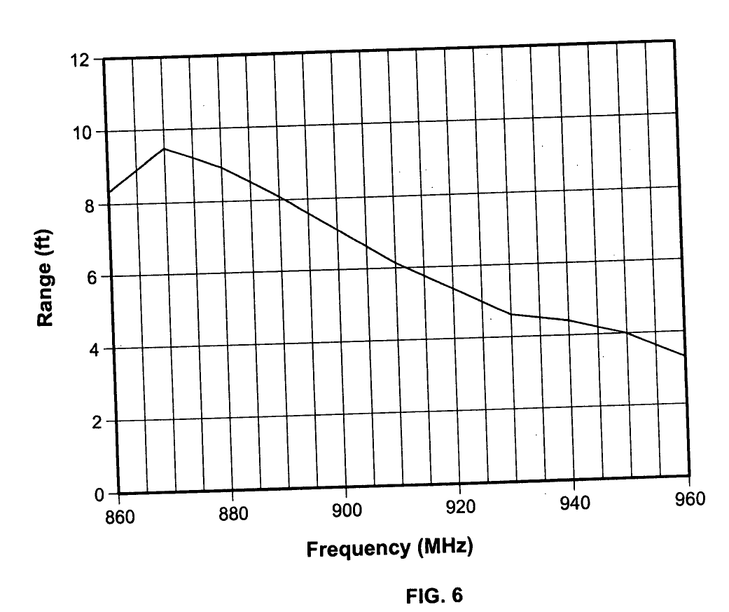

FIG. 6 shows exemplary test results for the “Intermec” encoded RFID tag antenna described in connection with FIGS. 5A-B, such as may be measured using the anechoic chamber test setup described above in connection with FIG. 4. A typical result, for example, may comprise a maximum range of about 9.5 feet at a frequency of 869 MHz. Thus, an antenna of the described type may be configured to provide performance comparable to conventional RFID tag antennas, and may be used interchangeably therewith.

Having thus described a preferred embodiment of a machine-readable, human-readable RFID tag antenna for an RFID system, it should be apparent to those skilled in the art that certain advantages of the within system have been achieved. It should be understand that the foregoing is exemplary rather than limiting in nature, and that various modifications, adaptations, and alternative embodiments thereof may be made within the scope and spirit of the present invention. For example, the invention is not limited to use with a particular substrate, but may be constructed with any dielectric substrate. The present invention is also not limited to a particular antenna design. It may be extended to any typical RFID tag antenna design, for example, conventional dipole, loop, spiral, patch, slot, or meander designs, depending on desired antenna form, size and functional performance.

What is claimed is:

1. A radio frequency identification (RFID) tag comprising:
a substrate layer;
a semiconductor device disposed on the substrate layer; and
an antenna disposed on the substrate layer in electrical communication with the semiconductor device, the antenna comprising a first conductive trace and a plurality of second conductive traces intersecting the first conductive trace, the plurality of second conductive traces arranged to collectively define an optically readable symbol.

2. The RFID tag of claim 1, wherein the optically readable symbol further comprises a machine-readable symbol.

3. The RFID tag of claim 1, wherein the plurality of second conductive traces are oriented in parallel to each other.

4. The RFID tag of claim 3, wherein the second conductive traces each have varying widths and relative spacing to encode data in accordance with a known bar code symbol standard.

5. The RFID tag of claim 3, wherein the plurality of second conductive traces are oriented substantially perpendicular to the first conductive trace.

6. The RFID tag of claim 1, wherein the optically readable symbol further comprises a human-readable symbol.

7. The RFID tag of claim 6, wherein the second conductive traces are formed in the shape of letters.

8. The RFID tag of claim 6, wherein the second conductive traces are formed in the shape of a logo.

9. The RFID tag of claim 1, wherein the second conductive traces are in electrical communication with the first conductive trace.

10. The RFID tag of claim 1, wherein the antenna is selected from a group including a dipole, loop, spiral, patch, slot and meander.

11. An antenna for use in a radio frequency identification (RFID) tag having a substrate layer and a semiconductor device affixed to the substrate layer, the antenna comprising a first conductive trace and a plurality of second conductive traces intersecting the first conductive trace, the plurality of second conductive traces arranged to collectively define an optically readable symbol.

12. The antenna of claim 11, wherein the optically readable symbol further comprises a machine-readable symbol.

13. The antenna of claim 11, wherein the plurality of second conductive traces are oriented in parallel to each other.

14. The antenna of claim 13, wherein the second conductive traces each have varying widths and relative spacing to encode data in accordance with a known bar code symbol standard.

15. The antenna of claim 13, wherein the plurality of second conductive traces are oriented substantially perpendicular to the first conductive trace.

16. The antenna of claim 11, wherein the optically readable symbol further comprises a human-readable symbol.

17. The antenna of claim 16, wherein the second conductive traces are formed in the shape of letters.

18. The antenna of claim 16, wherein the second conductive traces are formed in the shape of a logo.

19. The antenna of claim 11, wherein the second conductive traces are in electrical communication with the first conductive trace.

20. The antenna of claim 11, selected from a group including a dipole, loop, spiral, patch, slot and meander.
